(19) United States
(12) Patent Application Publication
(10) Pub. No.: US 2005/0062992 A1
(43) Pub. Date: Mar. 24, 2005

(54) Image processing apparatus, image processing method, image processing program, and storage medium

(75) Inventors: Yasunari Kishimoto, Kanagawa (JP); Akihiro Ito, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/914,147

(22) Filed: Aug. 10, 2004

(30) Foreign Application Priority Data
Aug. 11, 2003 (JP) 2003-291393

(51) Int. Cl. H04N 1/60

(52) U.S. Cl. 358/1.9; 358/518

(57) ABSTRACT

An image processing apparatus for calculating a color gamut contour of an object device, includes a first limit-amount setting section, a first device-contour generating section, and a color converting section. The first limit-amount setting section designates a condition. The condition includes at least one of (a) a maximum amount of each color component in a color space of the object device, and (b) a minimum amount of each color component in the color space of the object device. The first device-contour generating section generates contour points forming the color gamut contour in the color space of the object device, which is limited by the condition. The color converting section converts the contour points in the color space of the object device into contour points in another color space.

### BACKGROUND OF THE INVENTION

1. Field of the Invention

The present invention relates to a technique for calculating a color gamut contour of an object device in a desired color space.

2. Description of the Related Art

When an input device fetches an image or an output device displays and/or prints an image, a color range that is fetched by each device and a color range that is reproduced by each device are limited because of the characteristics of each device. For example, when an image forming device outputs a given image and the given image includes a color that the image forming device cannot reproduce, conversion processing (color gamut compression processing) for setting this color to lie in the reproducible color range is performed. At this time, it is necessary to judge whether or not colors of the given image are reproducible. Further, when one color of the given image cannot be reproduced, it is necessary to examine how this color should be converted in order to lie in the reproducible color range. Therefore, the contour (color gamut contour) of the reproducible color range must be calculated in each device. The color gamut contour is utilized in various uses such as a case for making a color reproducing evaluation of the device, etc. as well as the color gamut compression processing.

Generally, in a device such as an image forming device, inks (color materials) of four or more colors including K (black ink) are utilized in forming an image. Colors of an image are expressed in a device color space with using colors of the color materials as elements. Further, in a color correction and the color gamut compression processing, it is desirable to perform these correction and processing in a color space, which does not depend on the characteristics of the device, and a device independent color space is utilized therein. For example, the CMYK color space corresponds to the former device color space. The CIELAB color space and the CIEXYZ color space are utilized in the latter device independent color space. Therefore, in the following explanation, for convenience, the CMYK color space is used as the device color space and the CIELAB color space is used as the device independent color space.

As mentioned above, the device independent color space is utilized in performing the color correction and the color gamut compression processing, and the device color space is used in actually forming an image. Therefore, it is necessary to convert a color space between the device independent color space and the device color space. A procedure for generating a color conversion coefficient at this time includes the following steps. For example, modeling is performed in a forward direction from the CMYK color space as the device color space to the CIELAB color space as the device independent color space in an image forming device. Then, a color conversion coefficient for performing conversion from the CIELAB color space as the device independent color space to the CMYK color space as the device color space is obtained using the reverse conversion. For example, a method disclosed in “Proc. of International Congress of Imaging Science 2002 (2002, p. 413-141, Makoto Sasaki and Hiroaki Ikegami)” can be utilized as a model generation method. Generally, the accuracy of the model in the reverse direction is worse than that of the model in the forward direction.

Further, as mentioned above, processing such as the color gamut compression processing, which requires a color gamut of a device, is performed in the device independent color space. Accordingly, it is necessary to obtain the color gamut of the device in the device independent color space. For example, a method for constructing the color gamut contour utilizing a polygon is disclosed in JP-A-2003-8912 as a method for obtaining the color gamut in the device independent color space. FIG. 5 is an explanatory view of one example of the color gamuts in the device color space and device independent color space. For example, each color is independent when the color space of the device is an RGB color space or a CMY color space. Therefore, a solid shown in FIG. 5A is a color gamut, and its surface (contour) is the color gamut contour. When the surfaces of the solid are divided in a lattice shape, the color space contour in the device color space can be constructed. Further, when lattice points in the device color space obtained at this time are converted into those in a desired device independent color space, the lattice points in the device independent color space are obtained. The color gamut contour in the device independent color space can be obtained using the obtained lattice points in the device independent color space. FIG. 5 shows the schematic shape of the obtained color gamut contour. It is noted that the lattice points are omitted in FIG. 5.

### SUMMARY OF THE INVENTION

However, when the color gamut of the device of four or more colors as in the CMYK color space is determined, the three colors of CMY and K are not independent so that there is a problem. Specifically, it is not necessary to consider K in the color gamut contour constructed by primary colors (CMY) and secondary colors (RGB). However, in tertiary colors, CMY and K overlap and influence of K cannot be neglected. Accordingly, no color gamut contour obtained by the conversion from the CMY color space to the device independent color space can be utilized as it is. Therefore, JP-A-2003-8912 solves this problem as follows. CIELAB values are obtained with respect to vertexes of the secondary or more color of the CMY space in the CIELAB space, which is the device independent color space and a search is performed with respect to only a brightness axis.

In the search processing performed at this time, a candidate of the color gamut contour is determined and is converted from the CIELAB space as the device independent color space into the device color space. In the device color space into which the candidate is converted, it is judged that the candidate is located inside or outside the color gamut. Since the model of the reverse direction is used in the conversion at this time, the conversion accuracy is worse. Further, the search processing is repeatedly performed and the processing itself is complicated. Therefore, a problem exists in that it takes time in the processing and a large amount of processing cost is required.

As mentioned above, a portion requiring the consideration of K and a portion requiring no consideration of K exist in the color gamut contour. Therefore, in the following explanation, in the color gamut contour of the device independent color space shown in FIG. 5B, a portion of the color gamut contour, which requires no consideration of K and has brightness higher than that of CBMRYG is called an upper half. A portion of the color gamut contour, which requires the consideration of K and has brightness lower than that of CBMRYG, is called a lower half.

Further, a method disclosed in U.S. Pat. No. 5,883,632 converts a point of the color gamut contour of the device color space into a point of the device independent color space using the model of the forward direction from the device color space to the device independent color space; and connects the points in the device independent color space to generate the color gamut contour. Thus, the points on the color gamut contour in the device independent color space are obtained. However, the method disclosed in U.S. Pat. No. 5,883,632 tries to form the contour in the device independent color space, which has a curved surface, instead of the device color space easily described by a plane (polygon, etc.). Namely, a problem exists in that a complicated operation is required in performing operations of determining a small face and connecting vertexes in the three-dimensional device independent color space constructed by curved surfaces. This problem can be solved by a polygon making method for setting plural vertexes (e.g., vertexes of a triangle) and plural sets (e.g., a set of three vertexes in the case of a triangle) of vertexes in the device color space, which can be described by planes (one dimension or two dimensions) having a small dimension number, so as to wrap the device space. In this method, the respective vertexes are converted into the device independent color space, and no operation is performed in the device independent color space. Accordingly, it is difficult to reconcile accuracy and speed in U.S. Pat. No. 5,883,632. Further, no consideration is made with respect to a case in which a limit is set in the device color space.

In a method disclosed in U.S. Pat. No. 5,832,109 (U.S. Pat. No. 5,121,196), a color material limit is set in the device color space, and the color gamut contour in the device independent color space under this color material limit is obtained. However, very complicated processing in which, for example, an equal brightness curved surface is obtained in the device color space to calculate the color gamut contour is performed.

The present invention is made in consideration of the above situation. The invention provides an image processing apparatus and an image processing method, which can obtain a color gamut contour in another color space at high speed and low cost with high accuracy when a limit is set in a device color space; an image processing program for causing a computer to execute such an image processing method; and a storage medium that stores such an image processing program.

According to one embodiment of the invention, An image processing apparatus for calculating a color gamut contour of an object device, includes a first limit-amount setting section, a first device-contour generating section, and a color converting section. The first limit-amount setting section designates a condition. The condition includes at least one of maximum amounts of color components in a color space of the object device and minimum amounts of the color components in the color space of the object device. The first device-contour generating section generates contour points forming the color gamut contour in the color space of the object device, which is limited by the condition. The color converting section converts the contour points in the color space of the object device into contour points in another color space.

Further, according to one embodiment of the invention, an image processing apparatus for calculating a color gamut contour of an object device, includes a first device-contour generating section, a limit-amount setting section, a second device-contour generating section, and a color converting section. The first device-contour generating section generates contour points forming the color gamut contour in a color space of the object device. The limit-amount setting section designates a condition including a total-amount limit, which limits a sum of amounts of color components in the color space of the object device. The second device-contour generating section changes the contour points generated by the first device-contour generating section in accordance with the condition designated by the limit-amount setting section. The color converting section converts the contour points changed by the second device-contour generating section in the color space of the object device into contour points in another color space.

Furthermore, the above described image processing apparatuses may include a color gamut contour generating section that generates color gamut contour information by connecting a part of contour points, which are selectively extracted from the contour points in the another color space.

In such a configuration, the first device-contour generating section may generate the contour points, which are arranged at uneven intervals on axes connecting vertexes forming the color gamut contour in the color space of the object device. Also, the first device-contour generating section may generate a relation among the generated contour points in the color space of the object device. Then, the color converting section may maintain the relation generated by the first device-contour generating section before and after the conversion of the contour points in the color space of the object device.

It is noted that the color space of the object device may be a color space including at least four colors including black. It should be understood that the color space of the object device is not limited thereto, but may be the hexachrome expressed by six colors. The color space of the object device is not limited to a specific mode. A preferable color space of the group of contour points includes a device independent color space relating to a color sense such as CIELAB, CIEXYZ, CIECAM02, LMS and an opposite color. However, if the color space is sRGB (sYCC), which is a nominal device color space; a standard specification such as CIE, ISO/JIS, for example, Japan Color (Euro Color, SWOP); or Adobe RGB, which is standardized color space, such color space can be treated as the device independent color space and is not particularly limited.

In accordance with embodiments of the invention, the group of contour points forming the color gamut contour limited by a condition of the maximum amount, that of the minimum amount, and/or that of a total-amount limit in the color space of the object device, is generated in advance in the color space of the object device. This group of contour points is then converted into the group of contour points in the another color space. With this configuration, the conversion processing can be performed using a model of the forward direction from the color space of the object device to another color space. Accordingly, the color gamut contour in another color space can be uniquely determined. The processing does not include search processing, and the conversion processing can be performed by simple processing. Accordingly, there is an effect in that the color gamut contour can be precisely generated at high speed without requiring processing cost. Further, for example, if the relation among the group of contour points such as a polygon is determined in the color space of the object device, the relation can be maintained in another space. Accordingly, it is not necessary to reconstruct the group of contour points in another color space.

Further, when the generated color gamut contour is utilized, it is desirable to allot and arrange the group of contour points at an equal interval in the color space utilizing the information of the color gamut contour. To realize this allotment and arrangement, a part of the group of contour points may be selectively extracted from the generated group of contour points; color gamut contour information may be generated by connecting a part of the extracted contour points; and the group of contour points suitable for utilization may form the color gamut contour. Alternatively, the contour points, which are arranged at uneven intervals on axes connecting vertexes forming the color gamut contour in the color space of the object device, may be generated and the converted contour points may show a color gamut contour, which is used easily.

### BRIEF DESCRIPTION OF THE DRAWINGS

FIG. 1 is a block diagram showing a first embodiment of the invention.

FIGS. 2A and 2B are explanatory views of one example of a color gamut contour in a color space of an object device.

FIG. 3 is a schematic view of the color gamut contour constructed by a contour-point group obtained in a CIELAB color space.

FIG. 4 is a block diagram showing a second embodiment of the invention.

FIGS. 5A and 5B are explanatory views of one example of color gamut in the device color space and that in a device independent color space.

### DETAILED DESCRIPTION OF THE PREFERRED EMBODIMENT

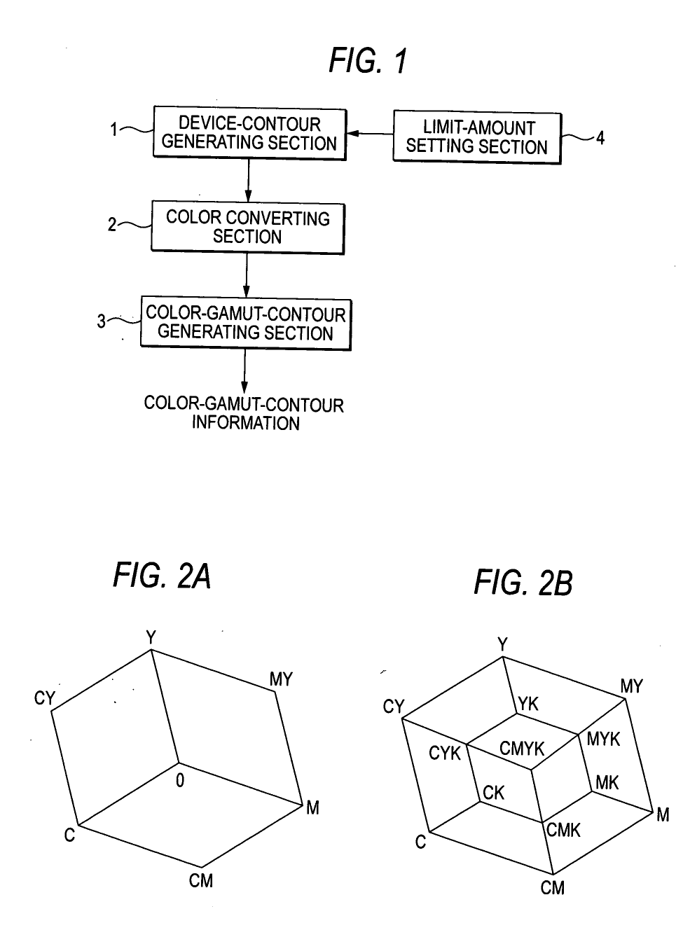

FIG. 1 is a block diagram showing a first embodiment of the invention. In FIG. 1, reference numerals 1, 2, 3 and 4 respectively designate a device-contour generating section, a color converting section, a color-gamut-contour generating section, and a limit-amount setting section. The color space of an object device and another color space are not limited. However, in the following explanation, the color space of the object device is set to the CMYK color space (primary colors are only C, Y, M and K); and another color space is set to the CIELAB color space, which is a device independent color space, because these color spaces are often utilized.

The device-contour generating section 1 generates a group of contour points forming a color gamut contour in the color space of the object device limited by conditions of a maximum limit amount, a minimum limit amount, and the like designated by the limit-amount setting section 4. At this time, points, which are extracted as the group of contour points, on the color gamut contour in the color space of the object device is arbitrary. For example, it is preferable to extract at least a vertex forming the color gamut contour, and a point on each axis connecting the vertexes. At this time, in a case where the point on each axis is extracted, the points are extracted at an equal interval. In order to facilitate utilizing the counter generated by the color-gamut-contour generating section 3 described later, the points on the color gamut contour may be extracted at uneven intervals. Further, the contour point can be similarly extracted at an equal interval or an uneven interval even on a color gamut contour face. For example, in a case where the color gamut contour is expressed by a polygon or the like, when the group of contour points is generated in the device-contour generating section 1, a relation among the contour points within the extracted group of contour points is constructed in advance. This relation among the contour points can be simply constructed since this relation is constructed in the color space of the object device.

The color converting section 2 converts the group of contour points in the color space of the object device generated by the device-contour generating section 1 into a group of contour points in another color space (here, a group of contour points in the CIELAB color space). A forward direction model of the object device can be utilized in this conversion.

For example, the color-gamut-contour generating section 3 selectively extracts contour points suitable for utilization from the group of contour points generated by the color converting section 2, and generates color gamut contour information by connecting the extracted partial group of contour points. Thus, information regarding the color gamut contour that is easily utilized can be obtained. Also, this color-gamut-contour generating section 3 may be omitted in the configuration shown in FIG. 1.

The limit-amount setting section 4 receives the designation of an arbitrary condition in the color space of the object device in accordance with necessity. The receiving condition is arbitrary, but conditions of a maximum limit amount, a minimum limit amount, a total-amount limit of each color, and the like can be received.

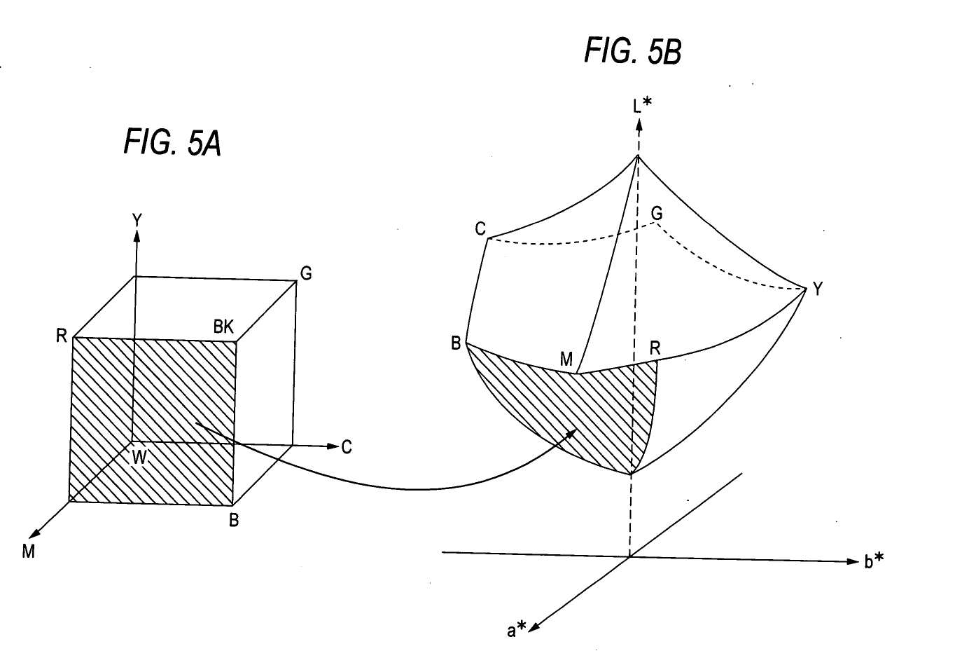

Next, the above configuration will be explained in more detail. First, the device-contour generating section 1 will be explained. FIG. 2 is an explanatory view of one example of the color gamut contour in the color space of the object device. FIG. 2A shows the upper half of the CMYK color space. FIG. 2B shows the lower half of the CMYK color space. For example, if the color space is three-dimensional, the color gamut contour in the color space of the object device is the surfaces of a cube as shown in FIG. 5A. Similarly, in the case of a four-dimensional color space, the color gamut contour is a polyhedral body of twelve faces in which the figures shown in FIGS. 2A and 2B are combined. Here, for the sake of simplicity, each of the CMYK colors takes 0% to 100%.

In the upper half shown in FIG. 2A, K always takes 0%. Further, the center is set to a point where the CMYK colors take 0%. Sides extending from the center to vertexes C, M and Y are point series in which the respective color elements change from 0% to 100%. On this side, the other three elements are zero. A vertex CY (=G(green)) is a point of C=Y=100% (M=K=0%). A side C-CY is a point series in which C changes from 0% to 100% while Y=100% (M=K=0%). Similarly, a side Y-CY is a point series in which Y changes from 0% to 100% while C=100%. Similar arguments hold true too with respect to vertexes MY (=R(red)) and CM(=B(blue)). Further, a face O-C-CY-Y is a set of points at which M=0%. The other two faces are also sets of points at which C=0% and those at which Y=0%. Namely, the upper half of the color gamut contour in the color space of the object device is a set of points at which K and one of the other colors take 0%.

In the lower half shown in FIG. 2B, circumferential vertexes C, CY, Y, MY, M and CM are the same points as those shown FIG. 2A, and overlap each other. Further, the central CMYK is a point at which C=M=Y=K=100%. Further, a vertex CK is a point at which C=K=100% and M=Y=0%. Similarly, a vertex YK is a point at which Y=K=100% and M=C=0%, and a vertex MK is a point at which M=K=100% and C=Y=0%. A vertex CYK is a point at which C=Y=K=100% and M=0%. Similarly, a vertex MYK is a point at which M=Y=K=100% and C=0%, and a vertex CMK is a point at which C=M=K=100% and Y=0%.

A side CMYK-CYK is a point series in which C=Y=K=0.100% and M changes from 0% to 100%. Similarly, a side CMYK-MYK is a point series in which M=Y=K=100% and C changes from 0% to 100%. A side CMYK-CMK is a point series in which C=M=K=100% and Y changes from 0% to 100%. Further, a side CYK-CY is a point series in which C=Y=100%; M=0%; and K changes from 0% to 100%. Similarly, a side MYK-MY is a point series in which M=Y=100%; C=0%; and K changes from 0% to 100%. A side CMK-CM is a point series in which C=M=100%; Y=0%; and K changes from 0% to 100%. Further, a side CK-C is a point series in which C=100%; M=Y=0%; and K changes from 0% to 100%. Similarly, a side YK-Y is a point series in which Y=100%; M=C=0%; and K changes from 0% to 100%. A side MK-M is a point series in which M=100%; C=Y=0%; and K changes from 0% to 100%.

Further, a face CMYK-CYK-CK-CMK is a set of points at which C=K=100%. The other two faces are also sets of points at which Y=K=100% and those at which M=K=100%. Namely, these three faces are sets of points in which K and one of the other colors take 100%. Further, a face C-CK-CYK-CY is a set of points at which C=100% and M=0%. Similarly, a face CY-CYK-YK-Y is a set of points at which Y=100% and M=0%. A face Y-YK-MYK-MY is a set of points at which Y=100% and C=0%. A face MY-MYK-MK-M is a set of points at which M=100% and C=0%. A face M-MK-CMK-CM is a set of points at which M=100% and Y=0%. A face CM-CMK-CK-C is a set of points at which C=100% and Y=0%. Namely, these six faces are a set of points in which one of C, M and Y colors takes 100% and one of these colors takes 0%.

Thus, points of the color gamut contour in the color space of the object device can be shown by the faces as shown in FIG. 2. As mentioned above, the points forming the color gamut contour are points satisfying a predetermined condition. The points except for the points satisfying the above condition are located in the interior of the color gamut.

The generated group of contour points in the color space of the object device can be extracted so as to be evenly arranged on the sides and the faces shown in FIG. 2, or be unevenly arranged in consideration of the arrangement in the device independent color space. In any case, it is sufficient to selectively set one or more contour points in the group of contour points in the color space of the object device. Also, only a required area may be selectively set therein.

Next, the limit-amount setting section 4 and the group of contour points generated by the device-contour generating section 1 when the limit-amount setting section 4 sets a condition, will be explained. For example, it is possible to give a condition of the maximum limit amount of an arbitrary color element and/or a condition of the minimum limit amount of an arbitrary color element by using a color gamut simulation of the object device. Here, a black ink amount K will be taken as a limit object, as one example.

When the maximum limit amount Ka and the minimum limit amount Km of the black-ink amount are designated in the limit-amount setting section 4, the device-contour generating section 1 generates the group of contour points of the object device as mentioned above. At this time, the device-contour generating section 1 sets a limit range of the black-ink amount in the lower half. The limit of the maximum amount is made an effect in such a way that components of the vertexes in FIG. 2B are correspondingly changed from 100% to Ka %. On the other hand, the minimum amount limit has an influence on the sides and the faces of the figure of FIG. 2B. However, since it is sufficient to perform similarity transformation in the color gamut contour, the group of contour points in the color space of the object device can be easily generated. It can be understood visually that the length of each side shown in FIG. 2B is shortened.

Here, the case of adding the condition of the maximum limit amount and that of the minimum limit amount with respect to the black ink K has been explained as an example. However, since the individual color element can be independently treated, conditions can be similarly added with respect to the other color elements. Specifically, when a condition is given to a color element other than the black ink, the group of contour points in the color space of the object device can be generated by controlling the lower and upper half ranges. When no limit condition is added, the group of contour points is generated from the color gamut contour shown in FIG. 2.

The color converting section 2 will next be explained. It is necessary for the color converting section 2 to obtain a color profile (color conversion coefficient) in advance so as to color-convert the group of contour points into a group of contour points in the CIELAB color space. This color profile may be a definition formula determined in a standard or a color profile obtained in the past. Alternatively, the color conversion coefficient may be generated by a method utilizing a neural network, a method utilizing a linear regression model, a principal component analysis or the like. Otherwise, a color patch may be directly output and measured by measurement values. Further, 3D-LUT (three-dimensional look-up table) may be also utilized. Here, a printer model of the forward direction is made using the method disclosed in “Proc. of International Congress of Imaging Science 2002 (2002, p. 413-141, Makoto Sasaki and Hiroaki Ikegami)”. The color converting section 2 uses this printer model to convert the group of contour points in the color space of the object device as an input into the group of contour points in the CIELAB color space. Thus, since the color conversion is performed using the model of the forward direction, the group of contour points can be obtained accurately.

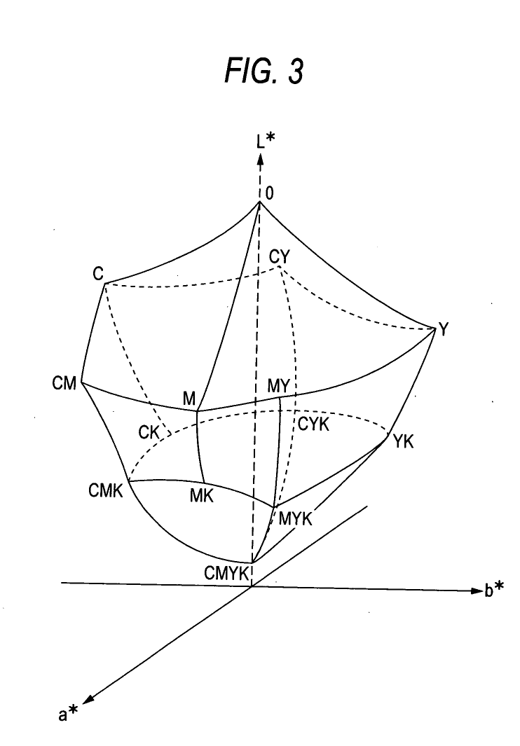

FIG. 3 is a typical view of the color gamut contour formed of the group of contour points obtained in the CIELAB color space. Each vertex, each side and each face shown in FIG. 2 are respectively converted into each vertex, each side and each face shown in FIG. 3. Each side and each face are not limited to a straight line and a plane in the CIELAB color space, but are generally formed of a curve and a curved surface.

As mentioned above, it is possible to obtain the group of contour points forming the color gamut contour of the object device in the device independent color space (CIELAB color space). In such a group of contour points, there is no problem even when the color space of the object device is not the CMYK color space, but is expressed by multiple colors such as hexachrome including six colors. Thus, the embodiment of the invention shows effects in the multiple colors.

On the other hand, it is convenient to generate the group of contour points as a 3D polygon so as to three-dimensionally visualize, evaluate, or quantify the color gamut of the object device in the device independent color space obtained as mentioned above. Therefore, the color-gamut-contour generating section 3 connects the group of contour points in the CIELAB color space as vertexes to generate and change faces into polygons. Thus, the color gamut contour of the object device can be three-dimensionally visualized using a general purpose visualizing tool and is easily utilized in various uses. When three-dimensional information connecting the group of contour points is generated, there is a case where it is desirous to remove an unnecessary area and arrange the vertexes at an equal interval or generate a detailed color gamut. In such a case, a part of the contour points may be selected from the group of contour points obtained by the color converting section 2, and the color gamut contour may be generated from the selected part of the contour points.

The polygon may be generated in the following procedure. First, the device-contour generating section 1 generates relations among the contour points as well as the group of contour points in the color space of the object device. Then, the color converting section 2 converts the relation into a relation among the contour points in the device independent color space as well as the group of contour points. Thus, the polygon can be easily formed in the color space of the object device, even if no polygon is generated in the device independent color space.

As mentioned above, in the first embodiment of the invention, the group of contour points is generated in the color space of the object device and is converted into the group of contour points in the device independent color space using the model of the forward direction. Accordingly, no searching repetitious processing as in the related art is performed, and the color gamut contour in the device independent color space can be simply and precisely obtained at high speed.

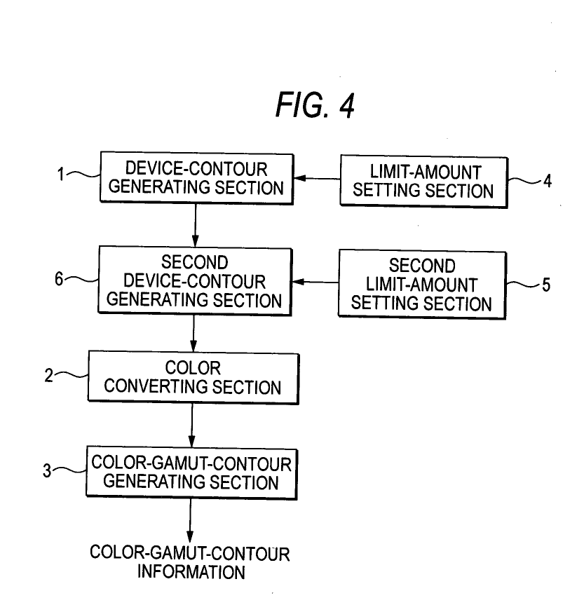

FIG. 4 is a block diagram showing a second embodiment mode of the present invention. In this figure, sections similar to those of FIG. 1 are designated by the same reference numerals and their explanations will be omitted. Reference numerals 5 and 6 respectively designate a second limit-amount setting section and a second device-contour generating section. The second embodiment shows a configuration for limiting the total amount of color materials in a color gamut simulation of the object device. Similar to the above first embodiment, the color space of the object device can be limited in the limit-amount setting section 4 with a condition of the total-amount limit, and the group of contour points can be generated. However, here described is an example in which first the group of contour points is generated and then, the group of contour points is changed so as to conform to the condition of total-amount limit.

The second limit-amount setting section 5 receives designation of the total-amount limit for limiting the sum of each color element in the color space of the object device, and transmits this designation to the second device-contour generating section 6. The second device-contour generating section 6 changes the group of contour points generated in the device-contour generating section 1 in accordance with the total-amount limit designated by the second limit-amount setting section 5. It is noted that the color converting section 2 color-converts the group of contour points in the color space of the object device, which has been changed by the second device-contour generating section 6, into the group of contour points in the CIELAB color space.

The above configuration will be further explained. First, the total amount G of the color materials is first designated in the second limit-amount setting section 5.

Namely, one of the following conditions
C+M+Y+K≦total amount G (1)
C+M+Y+K>total amount G (2)
is designated. Here, the formula 1 is used.

After the group of contour points is generated in the device-contour generating section 1, the second device-contour generating section 6 updates the generated group of contour points in the color space of the object device so as to have the total amount G or less. At this time, if an arbitrary contour point of the group of contour points satisfies the condition (formula 1) of the total amount G, no processing is performed. In contrast to this, if no arbitrary contour point satisfies the condition (formula 1), processing for the total-amount limit is performed. For example, this processing for the total-amount limit can be realized by fixing an amount of the color material of one color and constantly setting a constituent ratio of the other color material amounts so that the total amount of the color materials is equal to the set total amount G. Namely, when the color material an amount of which is fixed is I; the contour points of the device is (I, A1, A2, A3); and the device contour points, which are subject to the total amount limit are (I, A1′, A2′, A3′), A1′, A2′ and A3′ are obtained by the following formulas.
A1′=(A1×(G−I))/(A1+A2+A3)
A2′=(A2×(G−I))/(A1+A2+A3)
A3′=(A3×(G−I))/(A1+A2+A3) (3)
At this time, there are the following two regulating systems in accordance with the fixed color material. A regulating system 1 fixes K; fixes the ratio of C:M:Y; and adjusts a total amount of CMYK to be equal to the total amount G is made. Namely, this regulating system is a method for setting the fixed amount I of the formula 3 to an amount of K and setting A1, A2 and A3 to amounts of CMY, respectively. A regulating system 2 is a method for fixing one of amounts having maximum value among C, M, Y and K; fixing the ratio of the other three colors; and adjusting the total amount of CMYK so as to be equal to the total amount G. For example, if the color material having the maximum amount is C, the fixed amount I of the formula 3 is set to an amount of C, and A1, A2 and A3 are set to amounts of KMY, respectively.

Thus, it is possible to obtain the group of contour points satisfying the total-amount limit. The colors shown by the contour points are visually different due to the total-amount limit, but are points on the color gamut contour satisfying the total-amount limit in the color space of the object device. Accordingly, there is no problem in view of the object of obtaining the color gamut contour.

In the above explanation, the group of contour points satisfying the condition of the total-amount limit is obtained using the fixed amount and the proportional relation. However, in addition to this, it is possible to obtain the group of contour points satisfying the condition of the total-amount limit by various methods. For example, in the color space of the device, the total-amount limit is equivalent to processing for generating a new face, or to enlargement-contraction conversion of a face to which the total-amount limit is applied. The same effects can be obtained by generating and controlling a face to which the total-amount limit is applied. When the processing of the total-amount limit is performed, it is necessary to pay attention such that the relation between the respective contour points of the group of contour points before the change, and the relation between the respective contour points of the group of contour points after the change do not become different from each other.

The group of contour points changed in the second device-contour generating section 6 is sent to the color converting section 2. Similar to the first embodiment mode, this group of contour points is then converted into the group of contour points in the device independent color space. Thus, the color gamut contour in the device independent color space can be obtained.

Thus, the color gamut contour in the device independent color space satisfying the condition of the total-amount limit can be obtained. In order to judge whether or not a point in the device independent color space satisfies the total-amount limit, the related art converts the point into a point in the color space of the object device using the model of the reverse direction, and judges the condition of the total-amount limit. In comparison with the related art, the embodiments of the invention can obtain the group of contour points satisfying the total-amount limit, in the color space of the object device. Accordingly, the group of contour points in the device independent color space satisfying the total-amount limit can be simply obtained at high speed with high accuracy.

The entire disclosure of Japanese Patent Application No.2003-291393 filed on Aug. 11, 2003, including specification, claims, drawings, and abstract is incorporated herein by reference in its entirety.

1. An image processing apparatus for calculating a color gamut contour of an object device, comprising:
a first limit-amount setting section that designates a condition including at least one of:
maximum amounts of color components in a color space of the object device; and
minimum amounts of the color components in the color space of the object device;
a first device-contour generating section that generates contour points forming the color gamut contour in the color space of the object device, which is limited by the condition; and
a color converting section that converts the contour points in the color space of the object device into contour points in another color space.

2. The image processing apparatus according to claim 1, further comprising:
a second limit-amount setting section that designates a condition including a total amount of the color components in the color space of the object device; and
a second device-contour generating section that changes the contour points generated by the first device-contour generating section so as to satisfy the condition designated by the second limit-amount setting section, wherein:
the color converting section converts the contour points changed by the second device-contour generating section.

3. The image processing apparatus according to claim 1, wherein the first device-contour generating section generates the contour points, which are arranged at uneven intervals on axes connecting vertexes forming the color gamut contour in the color space of the object device.

4. The image processing apparatus according to claim 1, further comprising:
a color gamut contour generating section that generates color gamut contour information by connecting a part of contour points, which are selectively extracted from the contour points in the another color space.

5. The image processing apparatus according to claim 1, wherein:
the first device-contour generating section generates a relation among the generated contour points in the color space of the object device; and
the color converting section maintains the relation generated by the first device-contour generating section before and after the conversion of the contour points in the color space of the object device.

6. The image processing apparatus according to claim 1, wherein the color space of the object device is a color space including at least four colors including black.

7. An image processing apparatus for calculating a color gamut contour of an object device, comprising:
a first device-contour generating section that generates contour points forming the color gamut contour in a color space of the object device;
a limit-amount setting section that designates a condition including a total-amount limit, which limits a sum of amounts of color components in the color space of the object device;
a second device-contour generating section that changes the contour points generated by the first device-contour generating section in accordance with the condition designated by the limit-amount setting section; and
a color converting section that converts the contour points changed by the second device-contour generating section in the color space of the object device into contour points in another color space.

8. An image processing method comprising:
receiving a first condition including at least one of:
maximum amounts of color components in a color space of an object device; and
minimum amounts of the color components in the color space of the object device;
generating contour points forming a color gamut contour in the color space of the object device, which is limited by the first condition; and
converting the contour points in the color space of the object device into contour points in another color space to obtain a color gamut of the object device in the another color space.

9. The image processing method according to claim 7, further comprising:
receiving a second condition including a total amount of the color components in the color space of the object device; and
changing the contour points generated so as to satisfy the second condition, wherein:
the converting converts the contour points changed into the contour points in the another color space.

10. The image processing method according to claim 8, wherein the generating generates the contour points, which are arranged at uneven intervals on axes connecting vertexes forming the color gamut contour in the color space of the object device.

11. The image processing method according to claim 8, further comprising:
generating color gamut contour information by connecting a part of contour points, which are selectively extracted from the contour points in the another color space.

12. The image processing method according to claim 8, wherein:
the generating generates a relation among the generated contour points in the color space of the object device; and
the converting maintains the relation before and after the conversion of the contour points in the color space of the object device.

13. The image processing method according to claim 8, wherein the color space of the object device is a color space including at least four colors including black.

14. An image processing method comprising:
generating contour points forming a color gamut contour in a color space of an object device;
receiving a condition including a total-amount limit, which limits a sum of amounts of color components in the color space of the object device;
changing the contour points generated in accordance with the condition; and
converting the contour points changed in the color space of the object device into contour points in another color space.

15. A program which causes a computer to execute a image processing for calculating a color gamut contour of an object device, the image processing comprising:
receiving a first condition including at least one of:
maximum amounts of color component in a color space of the object device; and
minimum amounts of the color components in the color space of the object device;
generating contour points forming the color gamut contour in the color space of the object device, which is limited by the first condition; and
converting the contour points in the color space of the object device into contour points in another color space to obtain a color gamut of the object device in the another color space.

16. A program which causes a computer to execute a image processing for calculating a color gamut contour of an object device, the image processing comprising:
generating contour points forming a color gamut contour in a color space of an object device;
receiving a condition including a total-amount limit, which limits a sum of amounts of color components in the color space of the object device;
changing the contour points generated in accordance with the condition; and
converting the contour points changed in the color space of the object device into contour points in another color space.
